(19) United States
(12) Patent Application Publication
(10) Pub. No.: US 2006/0094463 A1
(43) Pub. Date: May 4, 2006

(54) Multiprocessing apparatus for a wireless terminal and method thereof

(75) Inventor: Min-Young Eom, Seoul (KR)

Correspondence Address: JONATHAN Y, KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics, Inc.

(21) Appl. No.: 11/261,367

(22) Filed: Oct. 27, 2005

(30) Foreign Application Priority Data
Oct. 28, 2004 (KR) 86842/2004

(51) Int. Cl. H04M 1/00

(52) U.S. Cl. 455/556.1

(57) ABSTRACT

A multiprocessing apparatus for a wireless terminal capable of implementing a direct access mode between internal processors of a wireless terminal and a method thereof. An operation signal processor is provided between a main processor and an application processor to enable a direct memory access mode for the application processor internal memory. The operation signal processor is enabled thereby implementing a direct access mode by indicating to the main processor that the application processor internal memory is being used.

### CROSS-REFERENCE TO RELATED APPLICATIONS

This application claims priority under 35 U.S.C. §119 for Korean Patent Application No. 86842/2004, filed on Oct. 28, 2004, which is hereby incorporated by reference as if fully set forth herein.

### FIELD OF THE INVENTION

The present invention relates to a wireless terminal, and more particularly, to a multiprocessing apparatus for a wireless terminal capable of implementing a direct access mode between internal processors of a wireless terminal, and a method thereof.

### BACKGROUND OF THE INVENTION

A wireless terminal not only performs a communication function but also provides various functions such as data recording, reproducing, and displaying, a digital camera, an MP3, 3D games, etc. The wireless terminal also provides multimedia services in a mobile environment through wireless connections.

In order to provide such various functions and services, a multiprocessor has been introduced for the wireless terminal. The multiprocessor is constructed as at least two processors being connected to each other on a single board, and is mainly composed of a main processor and an application processor.

An implementation mode for a multiprocessor in accordance with the related art can be divided into an indirect access mode and a direct access mode according to the method of memory access.

FIG. 1 is a block diagram showing a multiprocessor in an indirect access mode in accordance with the related art wherein a multiprocessor 100 in an indirect access mode comprises a main processor 110 and an application processor 120 connected to each other by an address port and a data bus.

The main processor 110 determines whether or not it can access the application processor 120 by always polling a state register of the application processor 120. When an internal memory of the application processor 120 is not being used, the main processor 110 separately transmits addresses and data through the address port.

When the logic address signal is low, the transmitted data is addresses. On the other hand, when the address signal is high, the transmitted data is data.

Since a cycle for addressing and a cycle for exchanging data exist separately, the main processor 110 cannot quickly perform various functions at the same time as reading and writing data of the application processor 120. Also, the main processor 110 cannot efficiently manage a register or a memory within the application processor 120.

FIG. 2 is a block diagram showing a construction of a multiprocessor in a direct access mode in accordance with the related art wherein a multiprocessor 200 in a direct access mode comprises a main processor 210 and an application processor 220 connected to each other not only by an address port and a data bus, but also by an operation signal port for transmitting operation signals such as a busy signal.

In sharing one memory (an internal memory of the application processor) between the main processor 210 and the application processor 220, when a first processor is able to access a second processor when the second processor is reading from or writing to a memory, the operation signal informs the first processor that the second processor is using the memory.

Generally, a multiprocessor having a direct access mode implements enhanced functions similar those of a multiprocessor having an indirect access mode. However, the direct access mode can be implemented only if the main processor can process an operation signal. The direct access mode can be implemented only if a hardware pin having the operation signal exists.

Generally, a low-cost processor omits a hardware pin used for the operation signal for cost reasons, therefore only an indirect access mode to be implemented in the multiprocessor.

When the multiprocessor is provided with a low-cost main processor such as a mobile station modem (MSM) chip for a wireless terminal, the operation signal is not processed in the main processor. Accordingly, the multiprocessor is implemented in an indirect access mode as shown in FIG. 1, so that the main processor cannot perform fast data processing with the application processor.

### SUMMARY OF THE INVENTION

Therefore, an object of the present invention is to provide a multiprocessing apparatus for a wireless terminal capable of implementing a direct access mode between internal processors of a wireless terminal, and a method thereof.

To achieve these and other advantages and in accordance with the purpose of the present invention, as embodied and broadly described herein, there is provided a multiprocessing apparatus for a wireless terminal, comprising: a main processor; an application processor; and an operation signal processor connected therebetween for implementing a direct access mode by processing operation signals of the main processor and the application processor.

Preferably, the operation signal processor comprises a register for latching the operation signals of the main processor and the application processor, and a timing generator. The timing generator is write or read enabled when the register is latched, and the main processor writes data to or reads data from an application processor internal memory.

Preferably, an operation signal from the application processor enables or disables the latch register. When the latch register is enabled, the application processor's memory is in use, and therefore another processor cannot access the application processor's memory. Conversely, when the latch register is disabled, the application processor's memory is available for use by another processor.

To achieve these and other advantages and in accordance with the purpose of the present invention, as embodied and broadly described herein, there is also provided a multiprocessing method for a wireless terminal, comprising: enabling an operation signal processor connected between the main processor and the application processor to inform a main processor that an application processor's internal memory is being used; anddisabling the register thereby indicating the main processor's use of the application processor's memory has been completed.

Preferably, the application processor enables the operation signal processor by transmitting an operation signal to the operation signal processor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a a multiprocessor in an indirect access mode in accordance with the related art;

FIG. 2 shows a a multiprocessor in a direct access mode in accordance with the related art;

FIG. 3 shows an exemplary construction of a wireless terminal according to a first embodiment of the present invention;

FIG. 4 shows a multiprocessing apparatus for a wireless terminal according to the present invention;

FIG. 5 is a block diagram of the multiprocessing apparatus for a wireless terminal according to one embodiment of the present invention;

FIG. 6 is a flowchart showing a multiprocessing method for a wireless terminal according to one embodiment of the present invention; and

FIG. 7 is a flowchart showing a multiprocessing method for a wireless terminal according to another embodiment of the present invention.

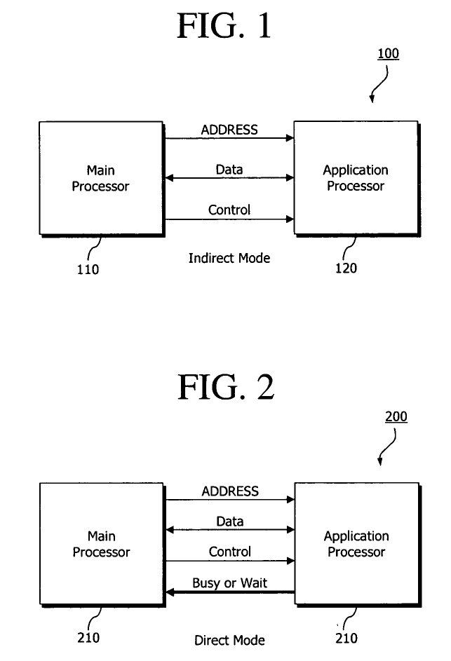

### DETAILED DESCRIPTION OF THE EMBODIMENTS

Reference will now be made in detail to the preferred embodiments of the present invention, examples of which are illustrated in the accompanying drawings.

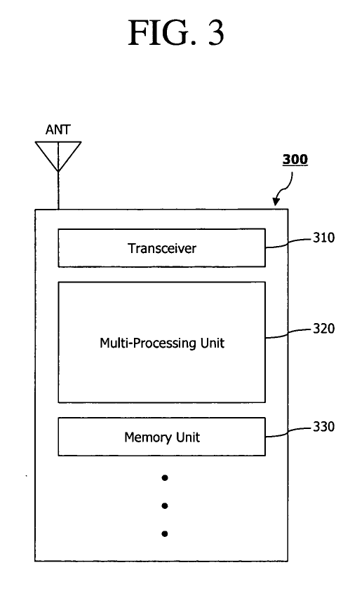

FIG. 3 shows construction of a wireless terminal according to one embodiment of the present invention, wherein a wireless terminal 300 may comprise a transceiver 310 for transmitting and receiving signals to and from a network, a multiprocessing apparatus 320 for performing various functions of the wireless terminal 300, and a memory 330 for storing data.

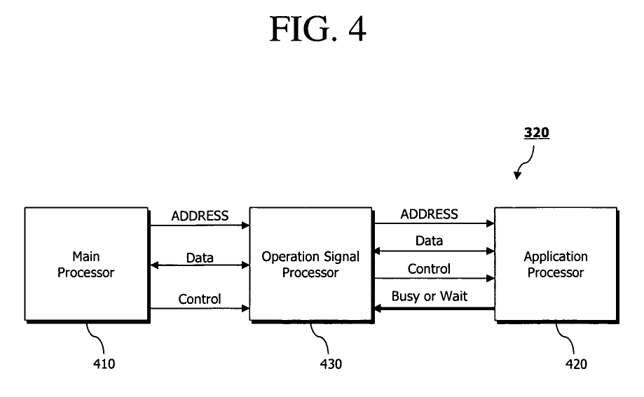

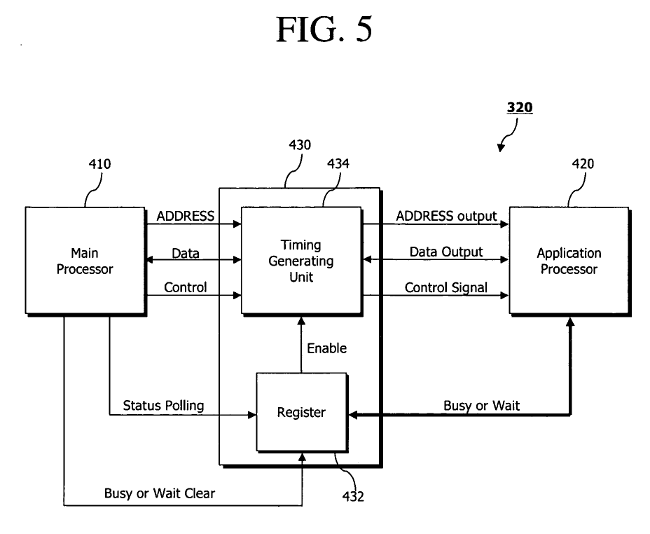

The multiprocessing apparatus 320 comprises a main processor for performing program operations and the basic functions of the wireless terminal, an application processor for performing specific application operations, and an operation signal processor for processing an operation signal between the main processor and the application processor. A more detailed construction and operation of the multiprocessing apparatus will be explained with reference to FIGS. 4 and 5.

FIG. 4 shows an exemplary construction of the multiprocessing apparatus 320 for a wireless terminal according to the present invention, wherein the multiprocessing apparatus 320 for a wireless terminal according to the present invention comprises a main processor 410, an application processor 420, and an operation signal processor 430 for processing an operation signal therebetween. The operation signal processor 430 can be constructed as glue logic. Glue logic is one or more simple logic circuits used to connect complex logic circuits together.

The main processor 410 and the application processor 420 share one memory, which is internal to the application processor. The application processor provides an operation signal such as a busy signal for preventing another processor from accessing the internal memory when in use.

The operation signal processor 430 is connected between the main processor 410 and the application processor 420, and informs the main processor 410 when the application processor 420 internal memory can be used. The operation signal processor 430 manages the data storage, the state information, and the signal generation between the two processors such that only one of the two processor may use the memory at a time. The operation signal processor 430 may be an erasable programmable logic device (EPLD) or a field programmable gate array (FPGA).

FIG. 5 is a view showing an exemplary detailed construction of the multiprocessing apparatus for a wireless terminal according to a first embodiment of the present invention, wherein the operation signal processor 430 may comprise a register 432 for latching the operation signals of the main processor 410 and the application processor 420, and a timing generation unit 434 for generating a write timing signal or a read timing signal, and for writing data to or reading the data from the application processor 420 internal memory.

The register 432 may be a flip-flop, and a set state thereof is changed according to the operation signal provided from the application processor 420. The register 432 is enabled when the application processor 420 provides a busy signal thereby preventing another processor from accessing the internal memory. When the application processor 420 completes the internal memory operation, the main processor 410 disables the register 432.

When the register 432 is in an enabled state, the timing generation unit 434 stores addresses of write data to be written by the main processor 410 to the application processor 420 internal memory, or stores addresses of data to be read by the main processor 410 from the application processor 420 internal memory. Then, when the register 432 is in a disabled state, the timing generator unit 434 is enabled to generate a write timing signal or a read timing signal. Then, the timing generator unit 434 writes the write data from the main processor 410 to a corresponding address of the application processor 420 internal memory, or transmits the data from the stored address to the main processor 410.

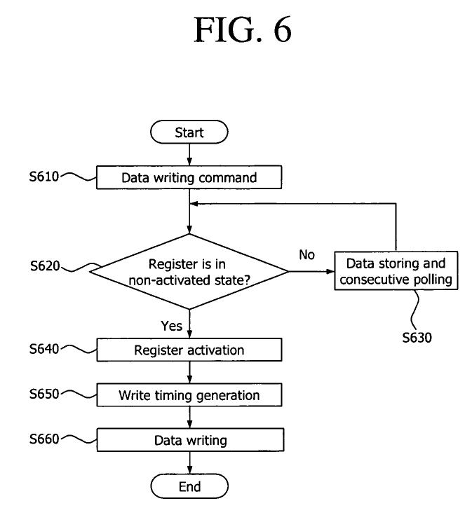

FIG. 6 is a flowchart showing an exemplary multiprocessing method for a wireless terminal according to one embodiment of the present invention, whereby data is to be written at the internal memory of the application processor (S610). The main processor determines whether the register of the operation signal processor is in a disabled state (S620).

If the register is enabled, data to be written is temporarily stored in the timing generation unit and the main processor continuously polls the register until the register is in a disabled state (S630).

If the register is in a disabled state or transitions to a disabled state during the polling operation, the main processor enables the register in order to prevent another processor from accessing (S640), enables the timing generating unit to generate a write timing signal (S650), and writes the temporarily stored data to the application processor internal memory (S660).

When the data write is completed, the register is disabled to allow an access of another processor or a consecutive access of the main processor (S670).

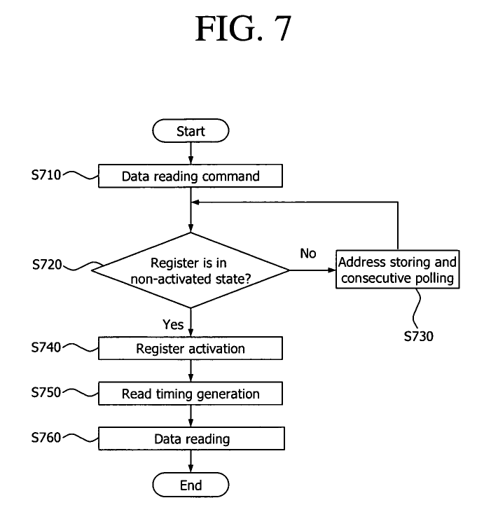

FIG. 7 is a flowchart showing an exemplary multiprocessing method for a wireless terminal according to another embodiment of the present invention, whereby data of the application processor internal is to be read (S710). The main processor determines whether the register of the operation signal processor is in a disabled state (S720).

If the register is in an enabled state, read addresses are stored in the timing generator unit and the main processor continuously polls the register until the register is in a disabled state (S730).

If the register is in a disabled state or transitions to a disabled state during the polling operation, the main processor enables the register in order to prevent another processor from accessing (S740), enables the timing generation unit to generate a read timing signal (S750), and reads data from the addresses that were temporarily stored and transmits the data to the main processor (S760).

When the data read is complete, the register is disabled to enable an access of another processor or a consecutive access of the main processor (S770).

As mentioned above, in the multiprocessing apparatus of a wireless terminal and the method thereof according to the present invention, when an application processor is connected to a main processor, an operation signal informs the main processor that a common memory is being used, thereby enabling the two processors to quickly access the common memory and to read and write data.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A multiprocessing apparatus for a wireless terminal, comprising:
a main processor;
an application processor; and
an operation signal processor connected therebetween for processing operation signals of the main processor and the application processor.

2. The apparatus of claim 1, wherein the operation signal processor comprises:
a register for generating an enable signal responsive to the operation signals of the main processor and the application processor; and
a timing generator unit responsive to the enable signal for accessing an internal memory of the application processor.

3. The apparatus of claim 2, wherein the register generates an enable signal when the application processor is busy.

4. The apparatus of claim 3, wherein the register continues to generate an enable signal while the accessing operation is in progress.

5. The apparatus of claim 4, wherein the main processor provides a clear signal when the accessing operation is completed, thereby forcing the register to a disabled state and to discontinue the enable signal.

6. The apparatus of claim 2, wherein accessing the application processor internal memory comprises writing data to the internal memory and reading data from the internal memory.

7. The apparatus of claim 1, wherein the operation signal processor is an erasable programmable logic device.

8. The apparatus of claim 1, wherein the operation signal processor is a field programmable gate array.

9. A multiprocessing method for a wireless terminal comprising the steps of:
informing a main processor that an application processor internal memory is being used by enabling an operation signal processor connected therebetween; and
informing the main processor that the application processor internal memory usage is completed by disabling the operation signal processor.

10. The method of claim 9, wherein the operation signal processor is an erasable programmable logic device.

11. The method of claim 9, wherein the operation signal processor is a field programmable gate array.

12. The method of claim 9, wherein the application processor enables the operation signal processor by transmitting an operation signal to the operation signal processor.

13. The method of claim 12, wherein the operation signal is a busy signal.

14. A multiprocessing method for a wireless terminal comprising the steps of:
determining whether a register of an operation signal processor is in an enabled state when data is to be written from a main processor to an internal memory of an application processor;
if the register is in a enabled state, storing data to be written temporarily in a timing generation unit, polling the register continuously until the register is in a non-enabled state;
if the register is in a disabled state, enabling the register to prevent access to the application processor internal memory by another processor; and
enabling the timing generation unit thereby writing the data to the application processor internal memory.

15. The method of claim 14 further comprising the step of disabling the register when writing the data is completed thereby allowing access to the application processor internal memory by another processor.

16. A multiprocessing method for a wireless terminal comprising the steps of:
determining whether a register of an operation signal processor is in an enabled state when data is to be read by a main processor from an internal memory of an application processor;
if the register is in a enabled state, storing a read address temporarily in a timing generation unit, polling the register continuously until the register is in a disabled state;
if the register is in a disabled state, enabling the register to prevent access by another processor; and
enabling the timing generation unit thereby reading the data from the application processor internal memory.

17. The method of claim 16 further comprising the step of disabling the register when reading the data is completed thereby allowing access to the application processor internal memory by another processor.

18. A wireless terminal comprising:
a transceiver for transmitting and receiving a signal to and from a network;
a multiprocessing apparatus having an operation signal processor for implementing a direct access mode by processing operation signals between a main processor and an application processor; and
a memory for storing data.

19. The wireless terminal of claim 18, wherein the operation signal processor comprises:
a register for generating an enable signal responsive to the operation signals of the main processor and the application processor; and
a timing generator unit responsive to the enable signal for accessing an internal memory of the application processor.

20. The wireless terminal of claim 19, wherein the register generates an enable signal when the application processor is busy.

21. The wireless terminal of claim 20, wherein the register continues to generate an enable signal while the accessing operation is in progress.

22. The wireless terminal of claim 21, wherein the main processor provides a clear signal when the accessing operation is completed, thereby forcing the register to a disabled state and to discontinue the enable signal.

23. The wireless terminal of claim 19, wherein accessing the application processor internal memory comprises writing data to the internal memory and reading data from the internal memory.

24. The wireless terminal of claim 19, wherein the operation signal processor is an erasable programmable logic device.

25. The wireless terminal of claim 19, wherein the operation signal processor is a field programmable gate array.
